(19) United States
(12) Patent Application Publication
(10) Pub. No.: US 2020/0063595 A1
(43) Pub. Date: Feb. 27, 2020

(54) COMPRESSED GAS AND RECYCLED LIQUID TURBINE POWER SYSTEM

(71) Applicant: Michael Newgent, Kapa'a, HI (US)

(72) Inventor: Michael Newgent, Kapa'a, HI (US)

(21) Appl. No.: 16/290,901

(22) Filed: Mar. 2, 2019

Related U.S. Application Data
(60) Provisional application No. 62/723,318, filed on Aug. 27, 2018.

(51) Int. Cl. F01D 15/10; F01D 13/00; H02K 7/18; B01D 45/14

(52) U.S. Cl. CPC F01D 15/10; F01D 13/003; F05D 2220/76; B01D 45/14; H02K 7/1823

(57) ABSTRACT

The Compressed Gas and Recycled Liquid Turbine Power System (CGRLTPS) generates rotational energy by converting energy stored within compressed gas into rotational energy and can convert that rotational energy into electricity.

### RELATED APPLICATIONS

This application claims priority to U.S. Provisional Patent Application No. 62/723,318, filed Aug. 27, 2018, and entitled “Compressed Gas and Recycled Liquid Turbine Power System” by Michael Newgent, which is incorporated herein by reference.

### BACKGROUND

People require energy on a skewed and sometimes unpredictable basis. Furthermore, they require firm, reliable energy, provided on demand. Despite the advancements of renewable energy, in many cases these requirements are still met by fossil fuels because of the unavailability, expense or unreliability of existing storage-to-energy conversion systems. Such fossil fuels are undesirable because of their pollution and because they are subject to a finite fuel supply which will ultimately run out.

However, intermittent solutions such as solar and wind are capable of providing significant amounts of energy that is not necessarily available at all times. Existing solutions suggest the use of batteries, which suffer from energy loss over time as well as challenges in scaling. Furthermore, batteries are another source of pollution because of their toxic chemicals, and they often have insignificant life-spans, at times requiring replacement in as few as a one to two years.

Given these problems with the existing solutions, what is needed is a reliable, scalable, energy conversion system which can convert stored energy into usable electricity on demand.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with Systems, tools, and methods that are meant to be exemplary and illustrative, not limiting in Scope. In various examples, one or more of the above described problems have been reduced or eliminated, while other examples are directed to other improvements.

The Compressed Gas and Recycled Liquid Turbine Power System (CGRLTPS) generates rotational energy around a shaft. The power source for the system is a compressed gas source and the system uses a liquid that emulsifies with the compressed gas. This emulsified liquid is propelled through one or more turbines which drive one or more power generators. The liquid is recycled through the system by use of a vortex separator which separates gas and liquid for re-use. The CGRLTPS is scalable so that it can be used for large or small applications.

Advantageously, electricity is generated from stored energy without the use of fossil fuels, where the source of the stored energy can be an intermittent power source such as wind solar, wave, or other natural phenomena providing intermittent power generation.

### BRIEF DESCRIPTION OF THE DRAWINGS

In the following description, several specific details are presented to provide a thorough understanding. One skilled in the relevant art will recognize, however, that the concepts and techniques disclosed herein can be practiced without one or more of the specific details, or in combination with other components etc. In other instances, well-known implementations or operations are not shown or described, in detail to avoid obscuring aspects of various examples disclosed herein.

FIG. 1 depicts an example of an assembled Compressed Gas and Recycled Liquid Turbine Power System.

FIG. 2 depicts an example of a cross section of a portion of a Compressed Gas and Recycled Liquid Turbine Power System.

FIG. 3 depicts an example of multiple turbines within a Compressed Gas and Recycled Liquid Turbine Power System displayed in a perspective view.

FIG. 4 depicts a turbine stack coupling of a Compressed Gas and Recycled Liquid Turbine Power System.

FIG. 5a depicts an example of a Pressure Chamber displayed in a vertical view.

FIG. 5b depicts an example of a Pressure Chamber displayed in a side view.

FIG. 5c depicts an example of a Pressure Chamber displayed from a direction of flow.

FIG. 5d depicts an example of a Pressure Chamber displayed in a perspective view.

FIG. 6a depicts an example of a Turbine from a side.

FIG. 6b depicts an example of a Turbine from above.

FIG. 6c depicts an example of a Turbine from a perspective.

FIG. 6d depicts an example of a Turbine from an alternative side.

FIG. 6e depicts an example of a Turbine from a direction of flow.

FIG. 7a depicts an example of a Vortex Separator from a perspective view

FIG. 7b depicts an example of a Vortex Separator from a side view.

FIG. 7c depicts an example of a Vortex Separator from above.

FIG. 7d depicts an example of internal components of a Vortex Separator

FIG. 8 depicts an example of multiple vortex separators within a Compressed Gas and Recycled Liquid Turbine Power System displayed in a perspective view.

FIG. 9a depicts an example of a Vortex Separator Impeller from a side view.

FIG. 9b depicts an example of a Vortex Separator Impeller from above.

FIG. 9c depicts an example of an Impeller of a Vortex Separator Impeller from a perspective.

FIG. 10a depicts an example of an Air Impeller from above.

FIG. 10b depicts an example of an Air Impeller from a side with a cut away view.

FIG. 10c depicts an example of an Air Impeller from a side with an alternative cut away view.

FIG. 11 depicts a flowchart of an example of a method for generating electricity.

FIG. 12a depicts an example of a Generation Array from a perspective angle.

FIG. 12b depicts an example of a Generation Array from a side angle.

FIG. 12c depicts an example of a Generation Array from above.

FIG. 13a depicts an example of an alternative Generation Array from above.

FIG. 13b depicts an example of an alternative Generation Array from a side angle.

FIG. 13c depicts an example of an alternative Generation Array from a perspective angle.

FIG. 14a depicts an example of a portion of a Compressed Gas and Recycled Liquid Turbine Power System expanded for visibility.

FIG. 14b depicts an example of a portion of a Compressed Gas and Recycled Liquid Turbine Power System compressed for inclusion into a housing.

FIG. 15a depicts an example of a Compressed Gas and Recycled Liquid Turbine Power System expanded for visibility.

FIG. 15b depicts an example of a Compressed Gas and Recycled Liquid Turbine Power System compressed for inclusion into a housing.

FIG. 16a depicts an example of a set of overlapping generation arrays.

FIG. 16b depicts an alternative example of a set of overlapping generation arrays from a side view.

FIG. 16c depicts an alternative example of a set of overlapping generation arrays.

FIG. 17 depicts an example of a set of multiple generation arrays.

FIG. 18 depicts an example of a housing for a Compressed Gas and Recycled Liquid Turbine Power System.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components etc. In other instances, well-known implementations or operations are not shown or described, in detail to avoid obscuring aspects of various examples disclosed herein.

The Compressed Gas and Recycled Liquid Turbine Power System (CGRLTPS) converts energy stored in compressed gas into rotational energy around a shaft. Liquid is emulsified in the compressed gas in a pressure chamber and the emulsified gas-liquid is then used to drive a turbine, which then turns a shaft. This rotational energy can be then used for mechanical processes or converted to electricity.

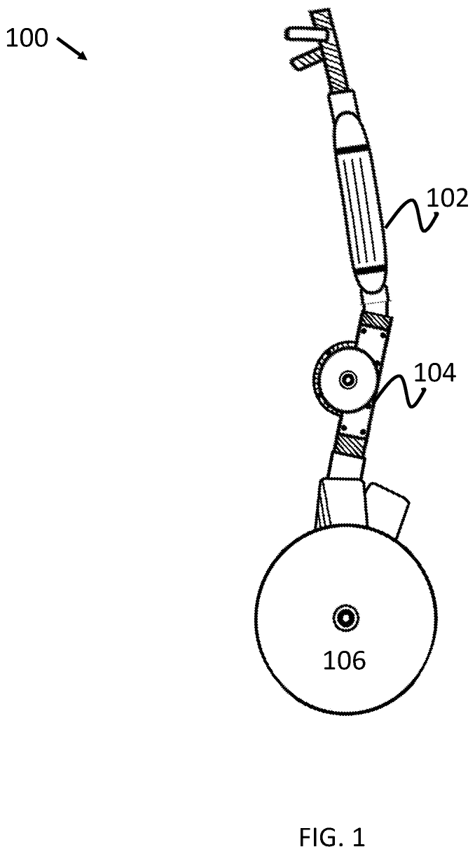

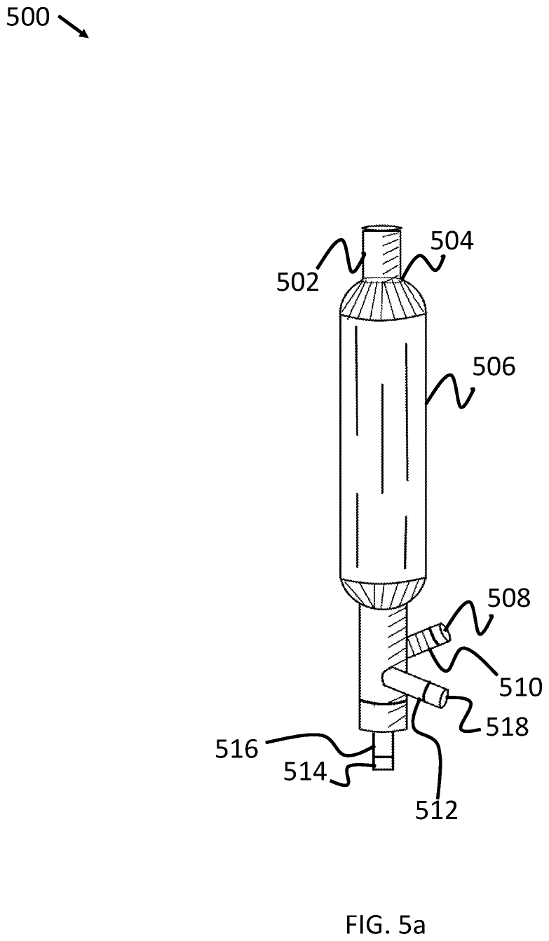

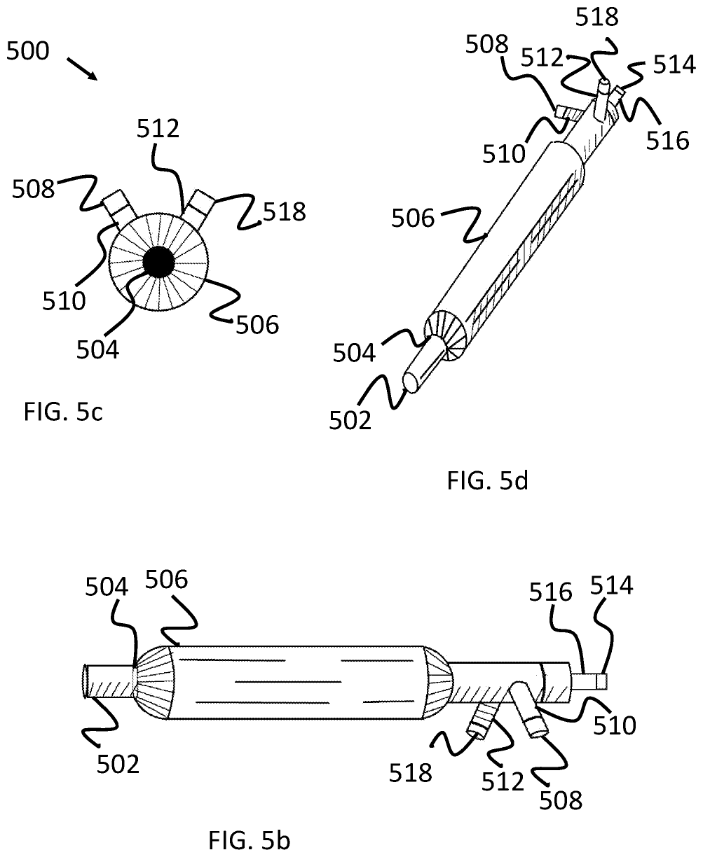

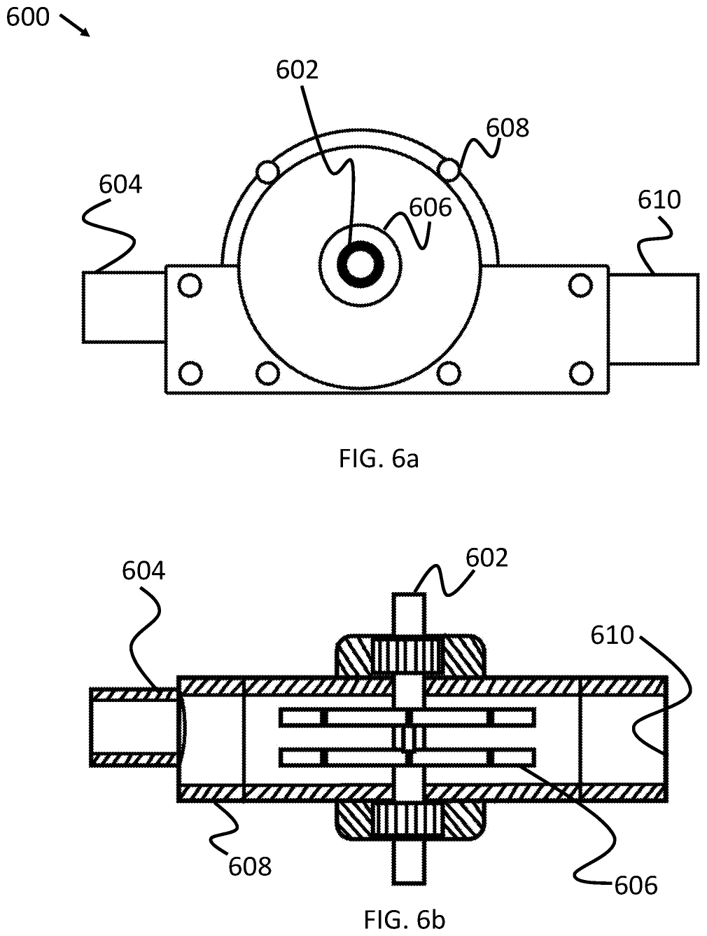

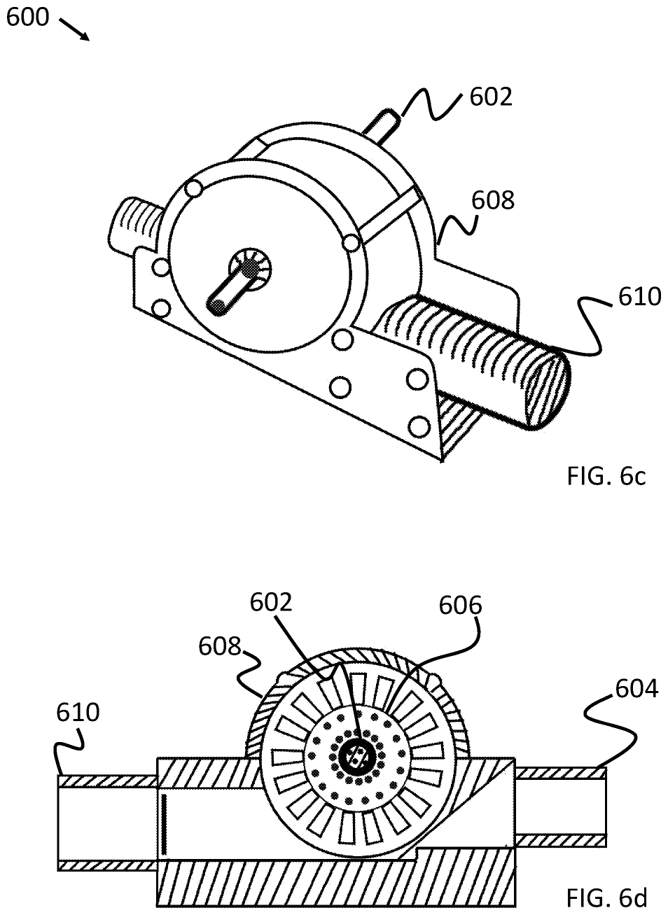

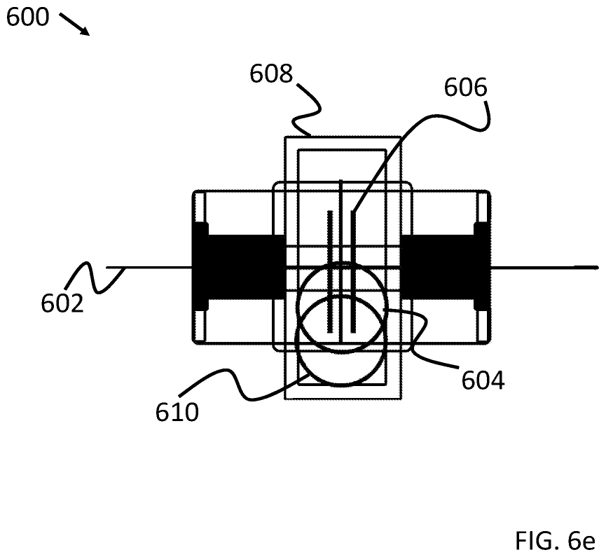

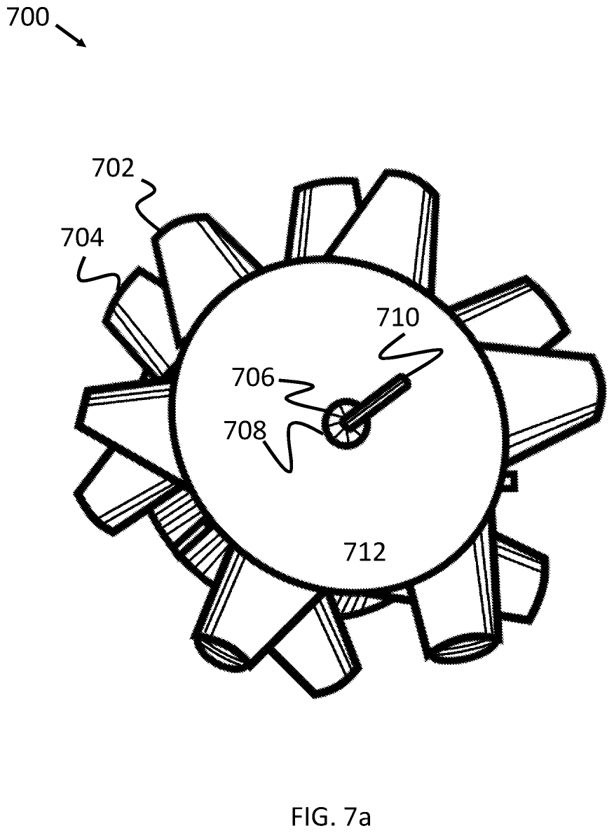

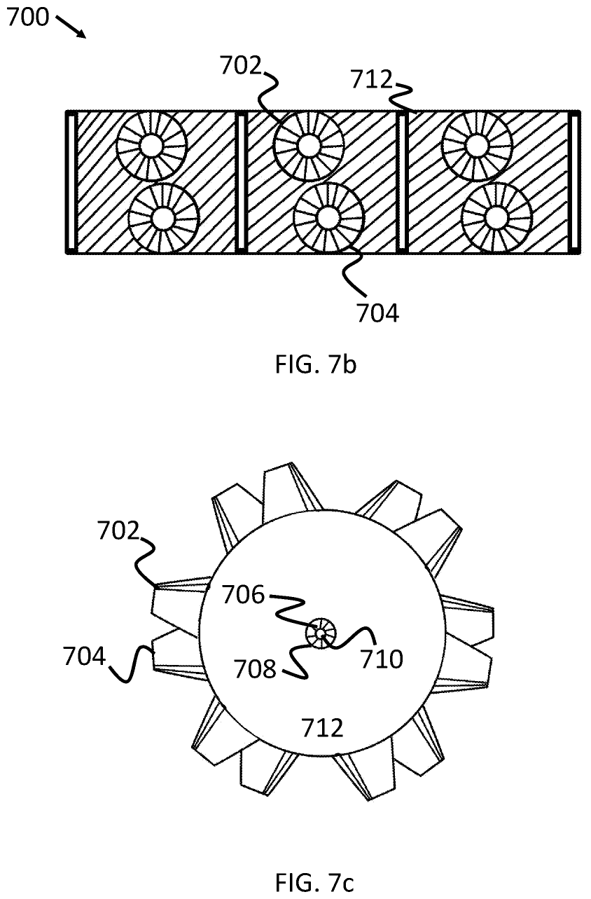

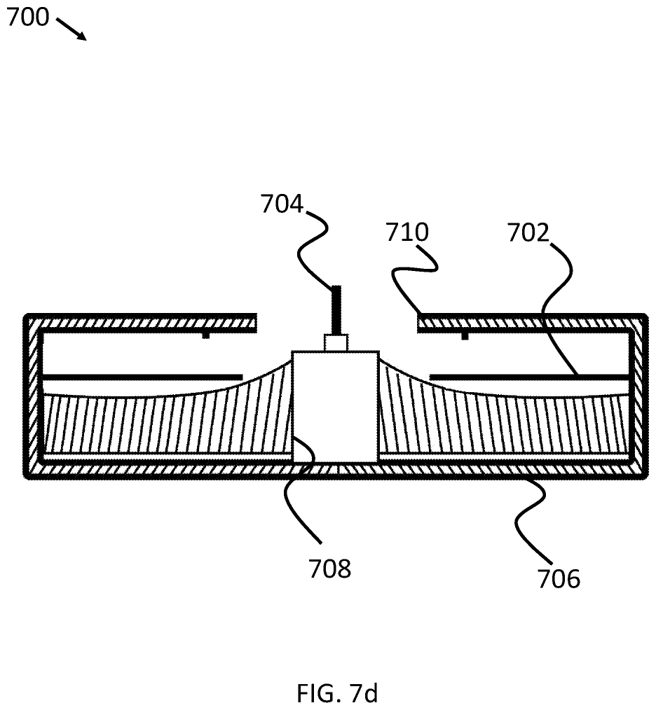

FIG. 1 depicts an example of a portion of an assembled Compressed Gas and Recycled Liquid Turbine Power System 100. FIG. 1 includes pressure chamber 102, turbine 104, and vortex separator 106. In the example of FIG. 1, pressure chamber 102 can be a pressure chamber as further discussed and described in reference to FIG. 5. In the example of FIG. 1, turbine 104 can be a turbine as further discussed and described in reference to FIG. 6. In the example of FIG. 1, vortex separator 106 can be a vortex separator as further described in reference FIG. 7.

In the example of FIG. 1, in operation, pressure chamber 102 is filled with compressed gas and liquid, emulsifying the two into a pressurized emulsified gas-liquid. Pressure chamber 102 is controlled to release emulsified gas liquid into the turbine 104, which impacts turbine blades within the turbine 104, causing a shaft within the turbine to rotate. The emulsified gas-liquid then exits the turbine 104 and is received into the vortex separator 106, which is separated by an impeller within the vortex separator 106 and returned to a pressure chamber for reuse.

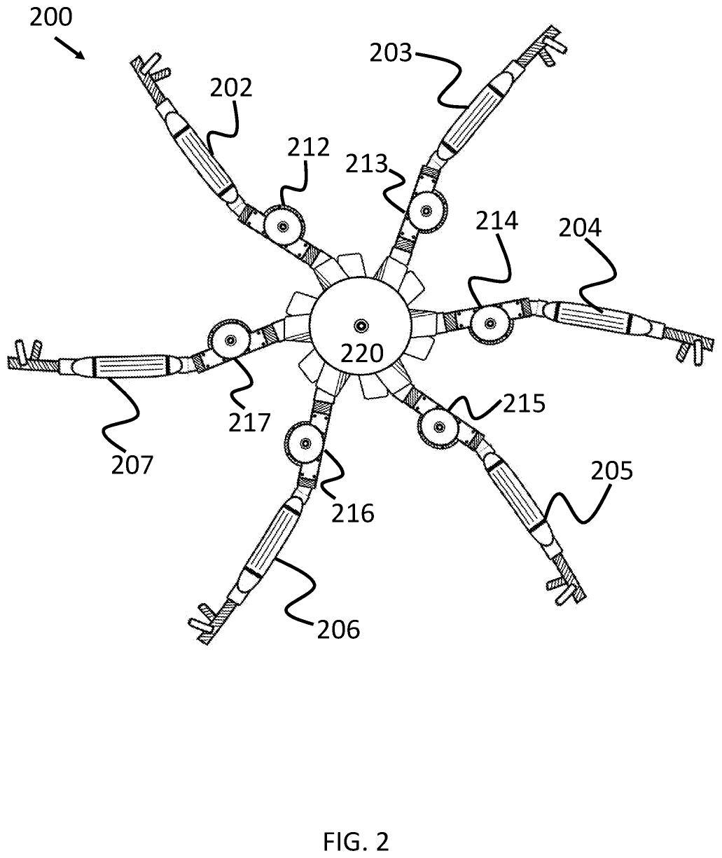

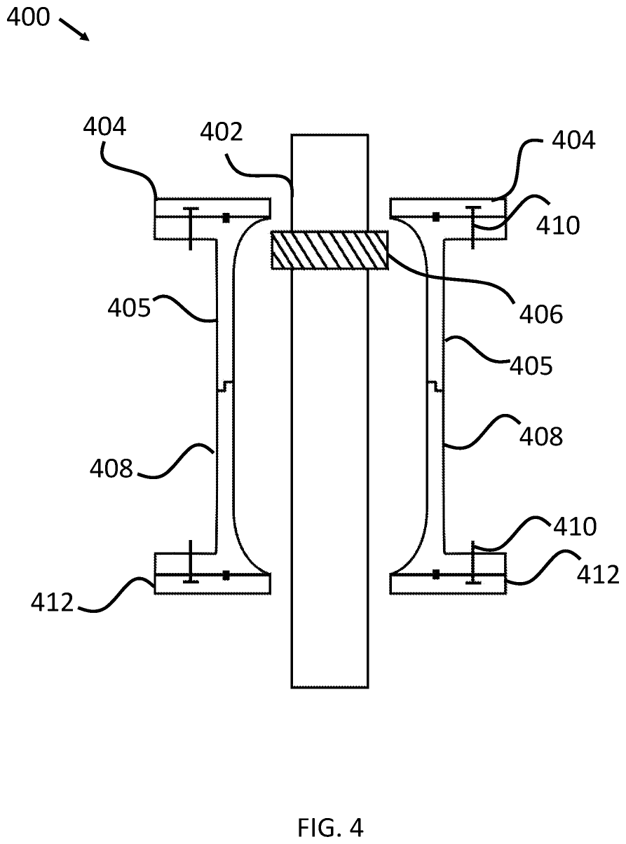

FIG. 2 depicts an example of a cross section of a portion of a Compressed Gas and Recycled Liquid Turbine Power System 200. In the example of FIG. 2, six compression chambers 202-207 are coupled to six turbines 212-217 and the six turbines are coupled to a vortex separator 220. In the example of FIG. 2, pressure chambers 202-207 can each be a pressure chamber as further discussed and described in reference to FIG. 4. In the example of FIG. 2, turbines 212-217 can each be turbines as further discussed and described in reference to FIG. 6. In the example of FIG. 2, vortex separator 220 can be a vortex separator as further described in reference FIG. 6.

In the example of FIG. 2, in operation, the six compression chambers 202-207 each provide compressed emulsified gas-liquid to the six turbines 212-217, which drive six turbine shafts passing through the six turbines 212-217. The six turbines 212-217 can be charged and discharged in patterns, for example, pressure chamber 203, pressure chamber 205 and pressure chamber 207 can be charged and discharged contemporaneously driving turbine 213, turbine 215 and turbine 217. Then, in this example, pressure chamber 204, pressure chamber 206 and pressure chamber 207 can be charged while pressure chamber 203, pressure chamber 205 and pressure chamber 207 are being discharged and then in this example, pressure chamber 204, pressure chamber 206 and pressure chamber 207 can be discharged driving turbine 213, turbine 215 and turbine 217. In each release, the emulsified gas-liquid is released into the vortex separator 220, which separates the emulsified gas-liquid into gas and liquid. The gas is then exhausted, and the liquid is pumped back into the pressure chambers for reuse.

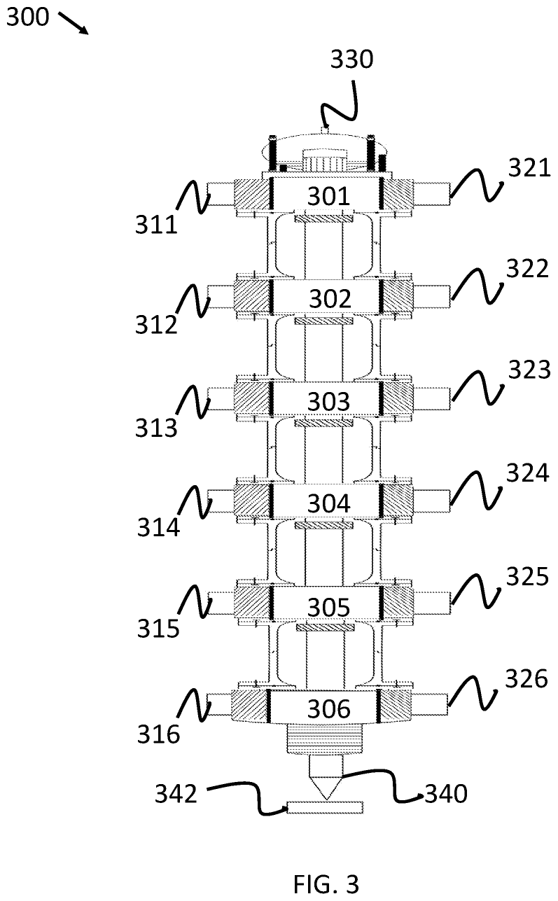

FIG. 3 depicts an example of multiple turbines 300 within a Compressed Gas and Recycled Liquid Turbine Power System. FIG. 3 includes turbines 301 through 306, directional inlets 311 through 316, outlets 321 through 326, shaft 330, balance point 340 and resting point 342. In the example of FIG. 3, the turbines 301-306 are operable to rotate common shaft 330 and balance point 340 minimizes friction on resting point 342.

In the example of FIG. 3 in operation, the six compression chambers release emulsified gas liquid in to the 6 turbines 301 through 306 via directional inlets 311 through 316. The emulsified gas liquid impacts blades located within turbines 301 through 306, which then turn common shaft 330. The rotational energy of common shaft 330 is then available to be used for mechanical applications or converted into electricity.

FIG. 4 depicts an improved turbine stack coupling 400 of a Compressed Gas and Recycled Liquid Turbine Power System. The turbine stack coupling 400 is shown from a cutaway perspective as components are cylindrical. Turbine stack coupling 400 includes turbine shaft 402, turbine stack coupling upper ring 404, turbine stack coupling upper section 405, turbine stack stop gap coupling 406, turbine stack coupling lower section 408, turbine stack attachment 410, and turbine stack coupling lower ring 412. Turbine shaft 402 can be a rod or pole of metal, graphite or another known or convenient material. The components of turbine stack coupling 400 including Turbine stack coupling upper ring 404, turbine stack coupling upper section 405, turbine stack stop gap coupling 406, turbine stack coupling lower section 408, turbine stack attachment 410 and turbine stack coupling lower ring 412 can be constructed of metal, polymer or another known or convenient material.

In the example of FIG. 4, the turbine stack coupling upper ring 404 is attached to turbine stack coupling upper section 405 by the use of one or more of turbine stack attachment 410. Turbine stack coupling upper section 405 is attached to turbine stack coupling lower section 408. Turbine stack coupling lower section 408 is attached to turbine stack coupling lower ring 412 by the use of one or more of turbine stack attachment 410. In the example of FIG. 4, in operation, shaft 402 can be levitated by magnetic forces causing stop gap coupling 406 to fill the center of the coupling upper ring 404 above coupling upper section 405 so as to minimize the flow of water down shaft 402.

FIG. 5a-d depict an example of a Pressure Chamber 500. FIG. 5a depicts an example of a Pressure Chamber 500 displayed in a vertical view. FIG. 5b depicts an example of a Pressure Chamber 500 displayed in a side view. FIG. 5c depicts an example of a Pressure Chamber 500 displayed from a direction of flow. FIG. 5d depicts an example of a Pressure Chamber 500 displayed in a perspective view. Pressure chamber 500 includes pressure chamber emulsified gas liquid outlet valve 502, pressure chamber emulsified gas liquid outlet 504, housing 506, pressure chamber exhaust outlet valve 508, pressure chamber exhaust outlet 510, pressure chamber liquid inlet 512, pressure chamber compressed gas inlet valve 514, pressure chamber compressed gas inlet 516 and pressure chamber liquid inlet valve 518.

Pressure chamber emulsified gas liquid outlet valve 502 can be any known or convenient valve for directing pressurized emulsified gas liquid. Pressure chamber emulsified gas liquid outlet 504 is an opening in housing 506 coupled to outlet valve 502. Housing 506 can be a vessel for holding pressurized emulsified gas liquid. Pressure chamber exhaust outlet valve 508 is a valve for releasing gas when filling the pressure chamber 508 with liquid and is the high point in the system relative to gravity. Pressure chamber exhaust outlet 510 is a tube extending from the housing 506 to pressure chamber exhaust outlet valve 508. Pressure chamber liquid inlet 512 is a pipe into housing 506. Pressure chamber compressed gas inlet valve 514 is a valve for allowing compressed gas into the compressed gas inlet 516. Pressure chamber compressed gas inlet 516 is a tube allowing compressed gas into housing 506. Pressure chamber liquid inlet valve 518 is a valve allowing liquid into the pressure chamber liquid inlet 512.

In the example of FIG. 5 in operation, pressure chamber exhaust outlet valve 508 is opened and pressure chamber liquid inlet valve 518 is opened. Liquid then enters pressure chamber liquid inlet 512 and passes into housing 506. At the same time, ambient-pressure gas within housing 506 is displaced by the entering liquid and travels out of the housing 506 through pressure chamber exhaust outlet 510, and out of the pressure chamber exhaust outlet valve 508. Once filled with a pre-determined amount of liquid, the pressure chamber liquid inlet valve 518 closes and the pressure chamber exhaust outlet valve 508 closes. Then the pressure chamber compressed gas inlet valve 514 opens and pressurizes the housing 506 with a pre-determined amount of compressed gas. The changes in pressure within the housing 506, caused by the entering compressed gas, temporarily emulsifies the liquid within the gas within the housing 506. Once filled with the pre-determined amount of compressed gas, the pressure chamber compressed gas inlet valve 514 closes. The pressure chamber emulsified gas liquid outlet valve 502 then opens and the emulsified gas liquid exits the housing 506 via the pressure chamber emulsified gas liquid outlet 504 and travels through the pressure chamber emulsified gas liquid outlet valve 502.

FIG. 6a-e depict an example of a Turbine 600. FIG. 6a depicts an example of a Turbine 600 from a side. FIG. 6b depicts an example of a Turbine 600 from above. FIG. 6c depicts an example of a Turbine 600 from a perspective. FIG. 6d depicts an example of a Turbine 600 from an alternative side. FIG. 6e depicts an example of a Turbine 600 from a direction of flow. Turbine 600 includes turbine shaft 602, emulsified gas liquid flow direction inlet 604, turbine blades 606, turbine housing 608, and turbine housing output-check-valve 610.

Turbine shaft 602 can be a rod of metal or another known or convenient material for receiving rotational energy. The emulsified gas liquid flow direction inlet 604 can be a tube, opening or similar structure for receiving emulsified gas liquid into the turbine blades 606. Turbine blades 606 are rotational structures including shaped surfaces for receiving emulsified gas liquid coupled to the turbine shaft 602 for receiving the emulsified gas liquid and forcing the rotation of the turbine shaft 602. Turbine housing 608 can be a metal, plastic, carbon-fiber or other structure for holding the turbine shaft 602 and the turbine blades 606. Turbine housing output-check-valve 610 can be a one-way valve for exhausting spent emulsified gas liquid.

In the example of FIG. 6 in operation, the emulsified gas liquid flow direction inlet 604 receives emulsified gas liquid and directs it to the turbine blades 606. The emulsified gas liquid impacts on the turbine blades 606 and force the turbine shaft 602 to rotate. The spent gas liquid then exits the turbine housing 608 via the turbine housing output-check-valve 610.

FIG. 7 depict an example of a Vortex Separator 700. FIG. 7a depicts an example of a Vortex Separator 700 from a perspective view. FIG. 7b depicts an example of a Vortex Separator 700 from a side view. FIG. 7c depicts an example of a Vortex Separator 700 from above. Vortex Separator 700 includes vortex separator emulsified gas liquid input 702, vortex separator liquid output 704, vortex separator liquid impeller 706, vortex separator gas output 708, vortex separator shaft 710, and vortex separator housing 712.

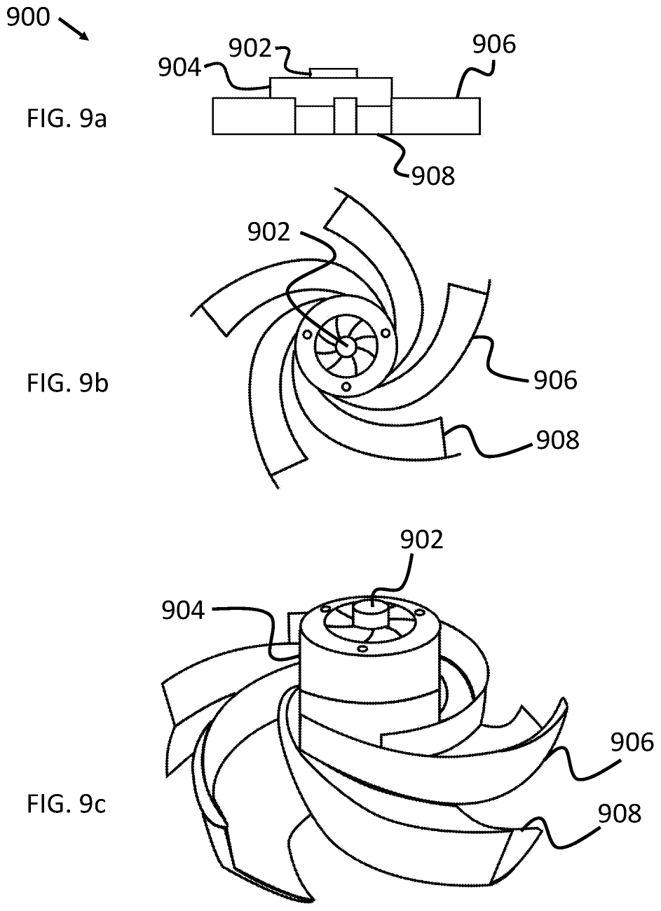

Vortex separator emulsified gas liquid input 702 can be a pipe into the housing 712. Vortex separator liquid output 704 can be a pipe out of the housing 712. Vortex separator liquid impeller 706 can be an impeller as discussed in reference to FIG. 9. Vortex separator gas output 708 can be an opening in housing 712 through which gas can be exhausted and through which vortex separator shaft 710 extends. Vortex separator shaft 710 is a drive shaft coupled to vortex separator liquid impeller 706. Vortex separator housing 712 can be a generally cylindrical shaped housing as depicted in FIG. 7a-7c and including vortex separator liquid impeller 706.

In the example of FIG. 7 in operation, liquid enters emulsified gas liquid input 702 and is separated by impeller 706 into gas and liquid. Gas is then exhausted out of vortex separator gas output 708 and liquid is exhausted out of vortex separator liquid output 704. The liquid can then be returned to a pressure chamber for reuse or directed into another device for storage.

FIG. 7d depicts an example of internal components of a Vortex Separator 700. Vortex separator 700 includes liquid-gas separator 702, vortex separator shaft 704, vortex separator housing 706, vortex separator impeller 708 and vortex separator gas output 710. Liquid-gas separator 702 can be a surface protruding internally into the vortex separator constructed out of plastic, metal, or another known or convenient material. Vortex separator shaft 704 can be a rotational shaft developed out of metal, composite, or other known or convenient material for driving one or more vortex separators. Vortex separator housing 706 can be a casing of plastic, metal, or another known or convenient material for separating liquid from gas. Vortex separator impeller 708 can be a vortex separator impeller as shown in reference to FIG. 9.

In the example of FIG. 7, in operation, the vortex separator shaft 704 rotates, turning the vortex separator impeller 708 thereby generating centripetal motion which forces the emulsified gas liquid to separate into gas and liquid because the physically heavier liquid is forced to edge of the housing 706. The liquid gas separator 702 retains the liquid within the housing 706 while the gas exits the housing 706 through the vortex separator gas output 710.

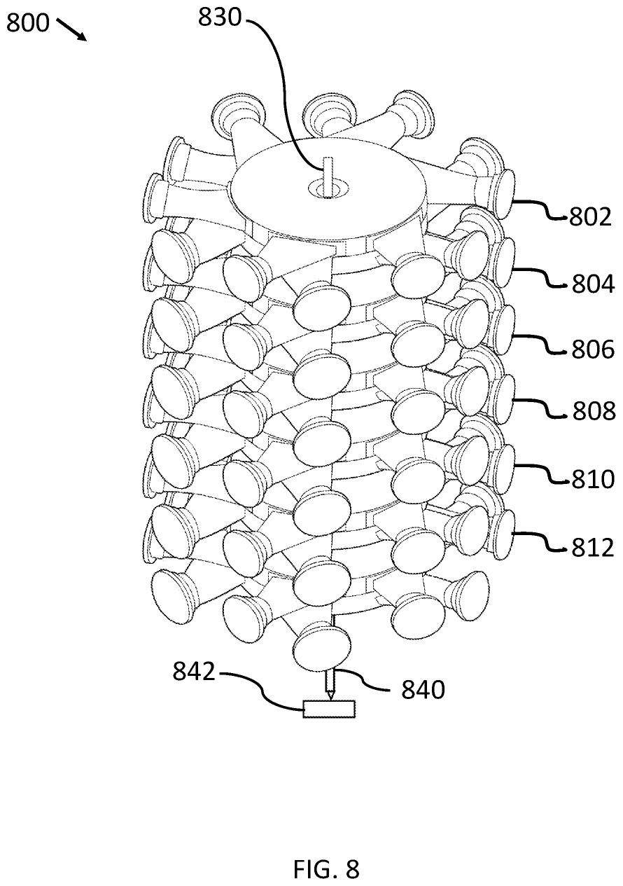

FIG. 8 depicts an example of multiple vortex separators within a Compressed Gas and Recycled Liquid Turbine Power System displayed in a perspective view. FIG. 8 includes vortex separators 802-812, shaft 830, balance point 840 and resting point 842. In the example of FIG. 8 the six vortex separators 802-812 are vortex separators as described in reference to FIG. 7. In the example of FIG. 8 in operation, the six vortex separators 802-812 rotate about shaft 830; and each receive emulsified gas liquid then each exhaust gas and recycle liquid as discussed in further depth in reference to FIG. 7.

FIG. 9a depicts an example of a Vortex Separator Impeller 900 from a side view. FIG. 9b depicts an example of a Vortex Separator Impeller 900 from above. FIG. 9c depicts an example of an Impeller of a Vortex Separator Impeller 900 from a perspective.

Vortex Separator Impeller 900 includes Vortex Separator Shaft 902, Vortex Separator Impeller Hub 904, Vortex Separator Impeller Blade 906, and Vortex Separator Impeller Blade 908. Vortex Separator Impeller 900 and its component parts can be a fabricated or assembled of components constructed from metal, composite material, or any known or convenient material. In operation, Vortex Separator Impeller 900 rotationally separates the emulsified gas-liquid by turning the impeller hub 904 within the emulsified gas liquid, causing the Vortex Separator Impeller blade 906 and the Vortex Separator Impeller blade 908 to turn, forcing the emulsified gas liquid to separate into gas and liquid so that the liquid can be returned to a reservoir for reuse or fed into another device for use.

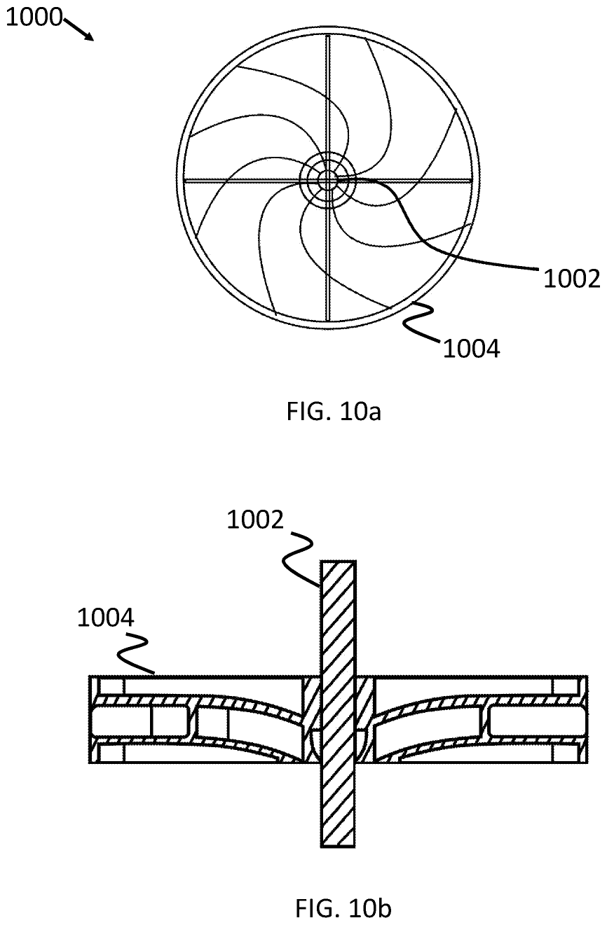

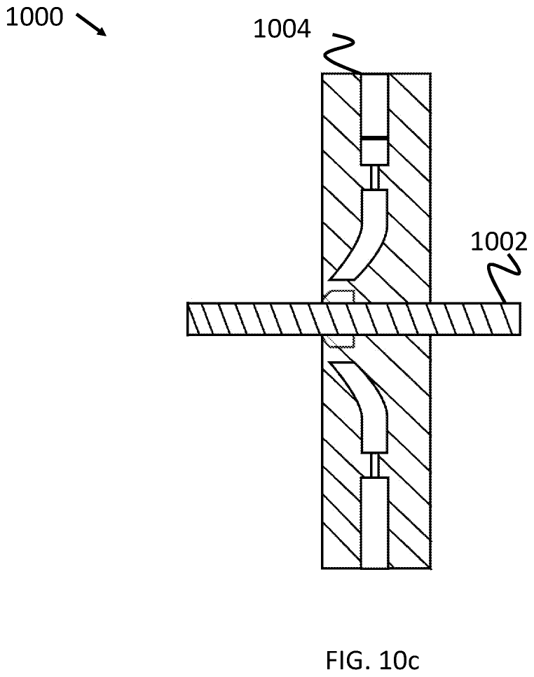

FIG. 10a-c depict an example of an Air Impeller 1000. FIG. 10a depicts an example of an Air Impeller 1000 from above. FIG. 10b depicts an example of an Air Impeller 1000 from a side with a cut away view. FIG. 10c depicts an example of an Air Impeller 1000 from a side with an alternative cut away view.

Air Impeller 1000 includes air impeller shaft 1002 and air impeller blades 1004. Air impeller shaft 1002 can be a drive shaft of metal, composite or any known or convenient material. Air impeller blades 1004 can be angled surfaces for generating force on emulsified gas-liquid. The air impeller functions to assist the turning of a vortex shaft by capturing air as it escapes from a vortex housing and thereby turning the energy of the escaping air into rotational energy. The air impeller is placed on top of a vortex stack and attached to its vortex shaft.

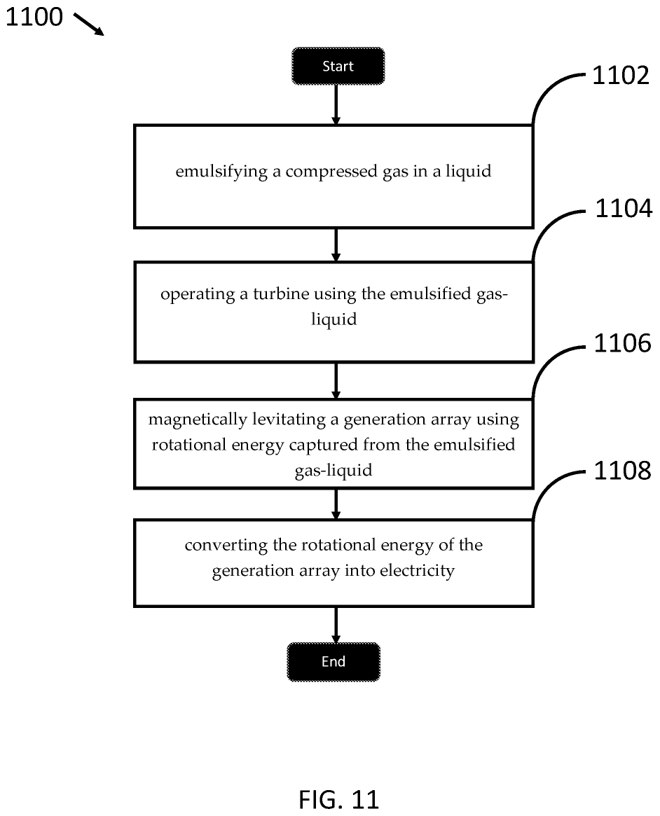

FIG. 11 depicts a flowchart 1100 of an example of a method for generating electricity. The method is organized as a sequence of modules in the flowchart 1100. However, it should be understood that these and modules associated with other methods as described herein may be reordered for parallel execution or into different sequences of modules.

In the example of FIG. 11, the flowchart starts at module 1102 with emulsifying a compressed gas in a liquid. In the example of FIG. 11, liquid is fed into a compression chamber and then compressed gas is fed into the chamber emulsifying the gas within the liquid at a high level of pressure. The pressurized, emulsified gas liquid is then usable to induce rotation in a device.

In the example of FIG. 11, the flowchart continues to module 1104 with operating a turbine using the emulsified gas-liquid. Therein, the emulsified gas liquid is fed into the turbine, impacting on blades which cause the turbine to turn and in turn cause a shaft coupled to the turbine to turn. The rotational energy produced by the turbine can then be used to rotate other devices.

In the example of FIG. 11, the flowchart continues to module 1106 with magnetically levitating a generation array using rotational energy captured from the emulsified gas-liquid. The implementation of the magnetically levitated device is can be obtained by rotating the generation array over a copper plate where magnets included in the generation array generate reflective magnetic fields which raises the generation array device off of the plate. Alternatively, static permanent magnets or electro-magnets can be used.

In the example of FIG. 11, the flowchart continues to module 1108 with converting the rotational energy of the generation array into electricity. Any known or convenient generation mechanism can be used. For example, electromagnetic induction can be used to create energy from the rotation of this device through rotating a magnet within a generation array. Having generated electricity, the flow chart terminates.

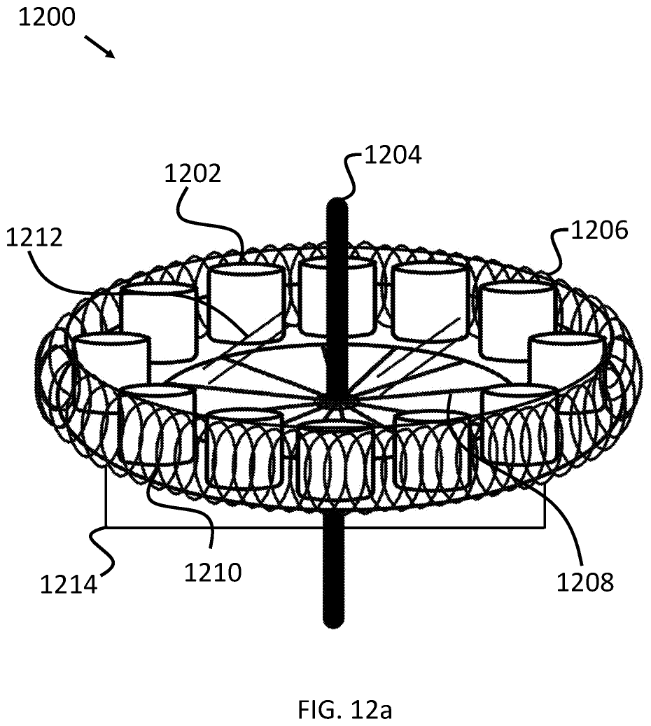

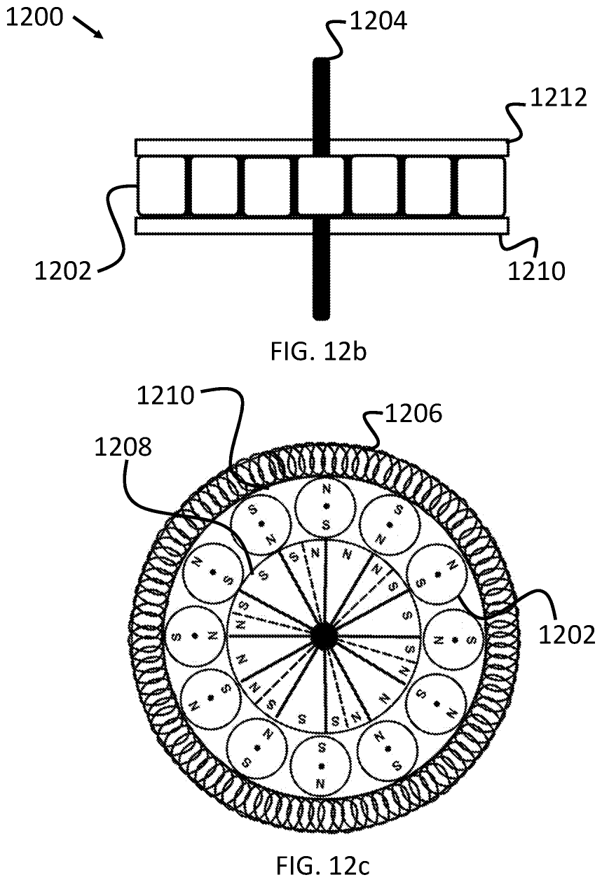

FIG. 12a depicts an example of a Generation Array 1200 from a perspective angle. FIG. 12b depicts an example of a Generation Array 1200 from a side angle. FIG. 12c depicts an example of a Generation Array 1200 from above. Generation Array 1200 includes generation magnet 1202, generation shaft 1204, generation induction coil 1206, levitation magnet 1208, generation unit support 1210, generation unit retainer 1212, and copper plate 1214.

In the example of FIG. 12, the generation magnet 1202 is a permanent magnet, one of a group of 12, although more or fewer could be used. In the example of FIG. 12, generation shaft 1204 is a drive shaft coupling the generation array 1200 to one or more turbines. In the example of FIG. 12, generation induction coil 1206 is a coil of wire which is not coupled to the remaining components of FIG. 12a-c, but is merely included for reference in comparison with the remaining parts for its important in generation. In the example of FIG. 12, levitation magnet 1208 is a permanent magnet, and as depicted is one of a group of 12 of alternating polarity magnets, although more or fewer could be used, and is selected from (1) a monopole north magnet, (2) a monopole south magnet, (3) a dipole north-south magnet, (4) a dipole south-north magnet or another known or convenient magnet. In the example of FIG. 12, generation unit support 1210 is a structure of plastic, non-magnetic metal, or another known or convenient material used to retain the generation magnet 1202 and such other generation magnets of generation array 1200 as may be used to construct generation array 1200. In the example of FIG. 12, generation unit support 1210 is a structure of plastic, non-magnetic metal or another known or convenient material used to retain the generation magnet 1202 and the other generation magnets of generation array 1200. In the example of FIG. 12, copper plate 1214 is a copper plate in close proximity, but not connected to, generation array 1200.

In the example of FIG. 12a-c, in operation, generation magnet 1202 is retained in place by generation unit support 1210 and generation unit retainer 1212. Generation shaft 1204 rotates, inducing levitation magnet 1208 to rotate about the generation shaft 1204. In operation, generation array 1200 is rotated in close proximity to copper plate 1214, thereby reflecting certain magnetic fields of the levitation magnet 1208 causing generation array 1200 to levitate on the reflected electromagnetic force. In the example off FIG. 12a-c, generation magnet 1202 rotates about the generation shaft 1204 in close proximity to the generation induction coil 1206, thereby inducing a current in the coil 1206.

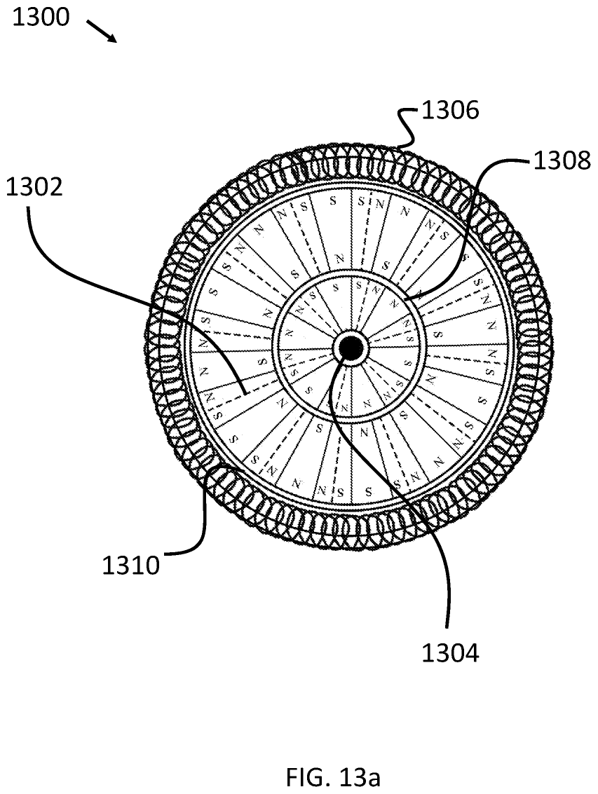

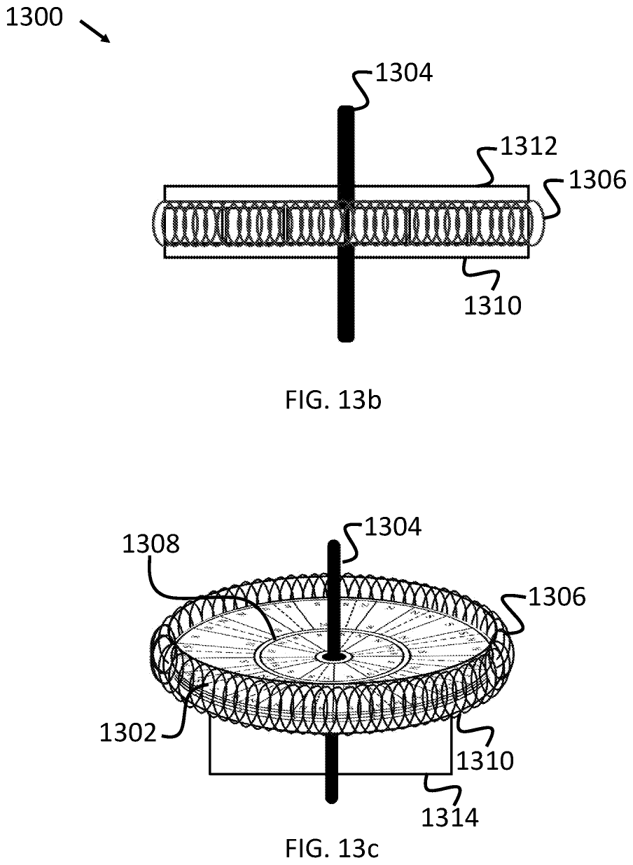

FIG. 13a depicts an example of an alternative Generation Array 1300 from above. FIG. 13b depicts an example of an alternative Generation Array 1300 from a side angle. FIG. 13c depicts an example of an alternative Generation Array 1300 from a perspective angle. FIG. 13. Generation Array 1300 includes generation magnet 1302, generation shaft 1304, induction coil 1306, levitation magnet 1308, generation unit support 1310, generation unit retainer 1312, and copper plate 1314.

In the example of FIG. 13, the levitation magnet 1308 is a permanent magnet, one of a group of 12, although more or fewer could be used. In the example of FIG. 13, generation shaft 1304 is a drive shaft coupling the generation array 1300 to one or more turbines. In the example of FIG. 13, induction coil 1306 is a coil of wire which is not coupled to the remaining components of FIG. 13a-c, but is merely included for reference in comparison with the remaining parts for its important in generation. In the example of FIG. 13, generation magnet 1302 is a permanent magnet, and as depicted is one of a group of 24 of alternating polarity magnets, although more or fewer could be used, and is selected from (1) a monopole north magnet, (2) a monopole south magnet, (3) a dipole north-south magnet, or (4) a dipole south-north magnet. In the example of FIG. 13a-c, generation unit support 1310 is a structure of plastic, non-magnetic metal, or another known or convenient material used to retain holding generation magnet 1302 along with other magnets; and generation unit retainer 1312 is a structure of plastic, non-magnetic metal, or another known or convenient material used retaining the generation magnet 1302 in place with other magnets for generation of electricity. In the example of FIG. 13a-c copper plate 1314 is a copper plate held in close proximity, but not connected to Generation Array 1310.

In the example of FIG. 13a-c, in operation, generation shaft 1304 rotates, inducing levitation magnet 1308 to rotate about the generation shaft 1304. In operation, generation array 1300 can be rotated in close proximity to copper plate 1314, thereby reflecting certain magnetic fields of the levitation magnet 1308 causing generation array 1300 to levitate on the reflected electromagnetic force. In the example off FIG. 13a-c, generation magnet 1302 rotates about the generation shaft 1304 in close proximity to the induction coil 1306, thereby inducing a current in the induction coil 1306.

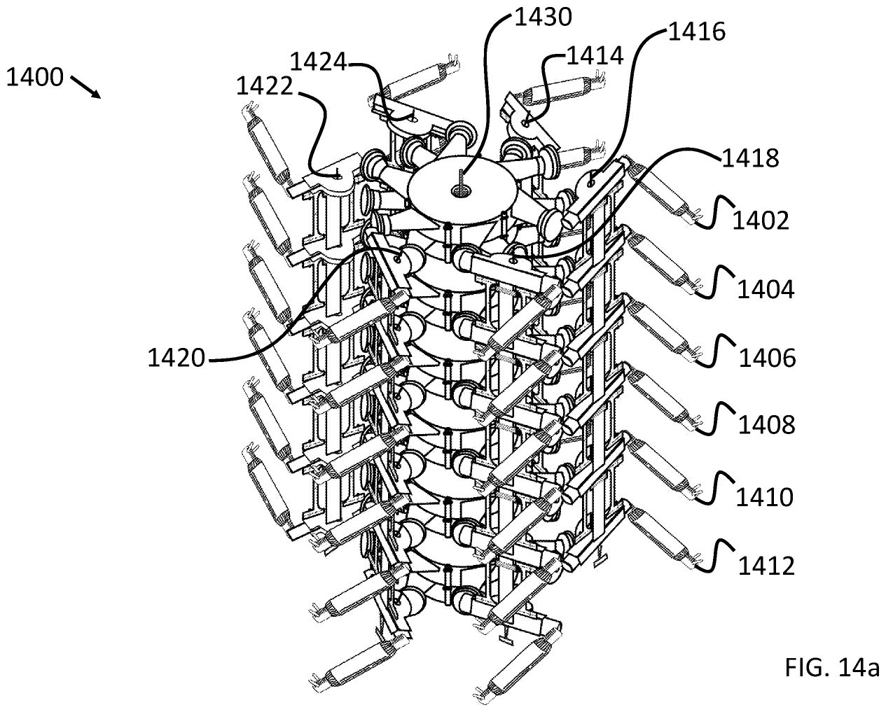

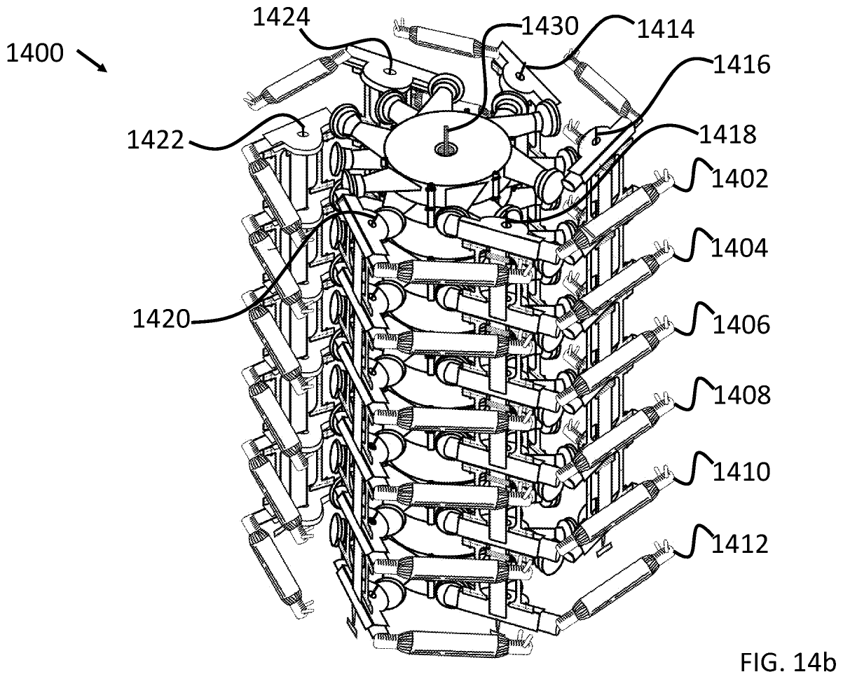

FIG. 14a depicts an example of a portion of a Compressed Gas and Recycled Liquid Turbine Power System 1400 expanded for visibility. FIG. 14b depicts an example of a portion of a Compressed Gas and Recycled Liquid Turbine Power System 1400 compressed for inclusion into a housing. Compressed Gas and Recycled Liquid Turbine Power System 1400 includes rows 1402-1412 collectively including thirty-six turbines arranged in six vertical stacks, each stack of turbines driving a shaft, including shafts 1414-1424. The thirty-six turbines are powered by thirty-six compression chambers and all turbines and compression chambers are organized into six rows. Each of rows 1402-1412 is organized as depicted in FIG. 2 with a single vortex separator coupled to six turbines, and each of the six turbines is coupled to an individual pressure chamber, powering the turbine with a shaft 1430 connecting the rows.

In the example of FIG. 14a, in operation, the thirty-six pressure chambers provide emulsified gas-liquid to the thirty-six turbines driving the six shafts 1414-1424. For each turbine, the emulsified gas-liquid exits the turbine and is received into one of six vortex separators. The vortex separator divides the emulsified gas-liquid into gas and liquid, exhausts the gas and returns the liquid to a pressure chamber for reuse. Each of the six shafts 1414-1424 can then output rotational energy or drive generation arrays to create electricity.

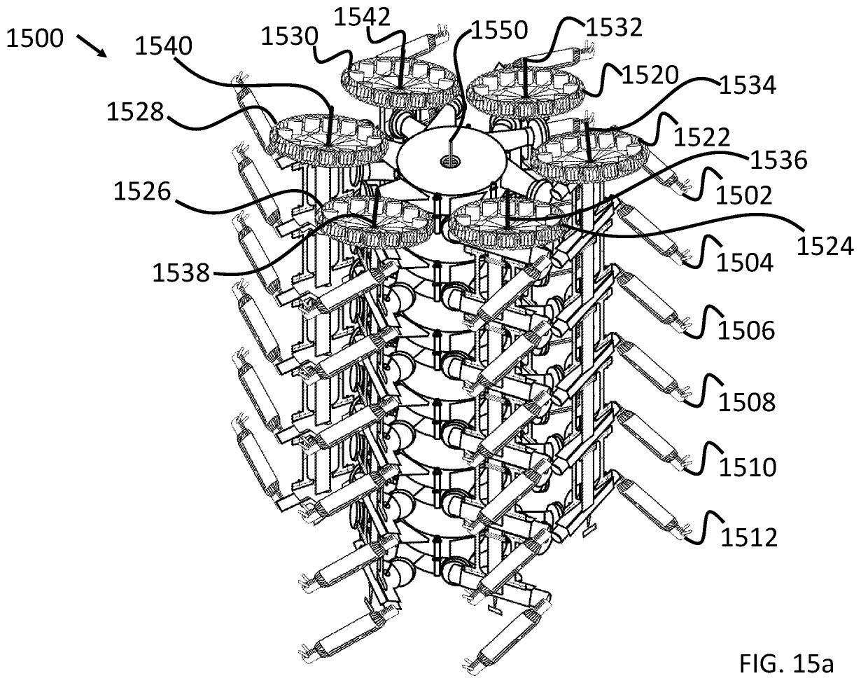

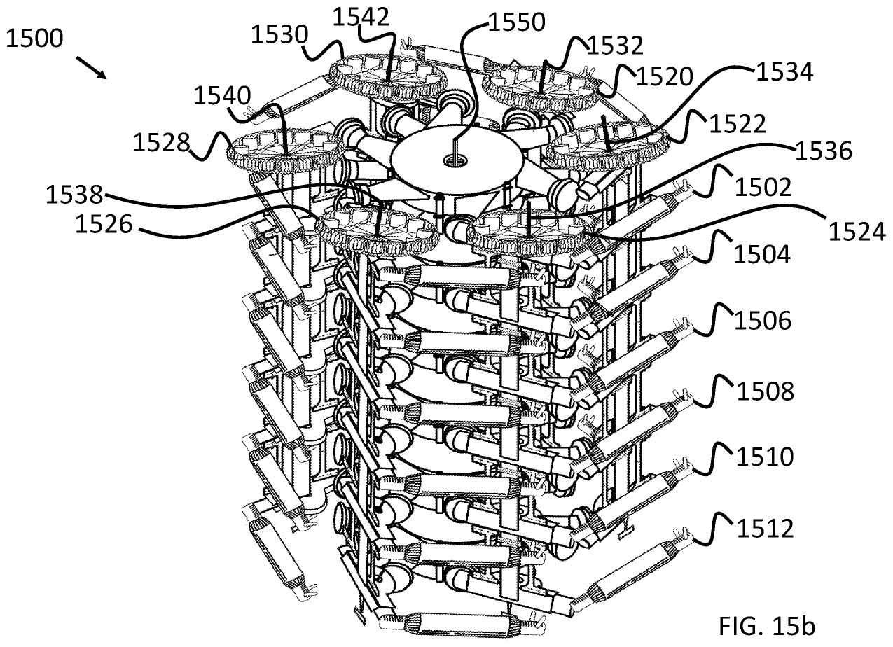

FIG. 15a-b depicts an example of a Compressed Gas and Recycled Liquid Turbine Power System 1500. Compressed Gas and Recycled Liquid Turbine Power System 1500 includes six generation arrays operable to create electricity through rotation driven by six stacks of turbines. In the example of FIG. 15a-b, the six generation arrays 1520-1530 are Generation Arrays as depicted in reference to FIG. 12a-c, but could be Generation Arrays as depicted in reference to FIG. 13a-c, or another known or convenient Generation Array. Compressed Gas and Recycled Liquid Turbine Power System 1500 is organized into includes rows 1502-1512 collectively including thirty-six turbines arranged in six vertical stacks, each stack of turbines driving a shaft, including shafts 1532-1542. The thirty-six turbines are powered by thirty-six compression chambers and all turbines and compression chambers are organized into six rows. Each of rows 1502-1512 is organized as depicted in FIG. 2a with a single vortex separator coupled to six turbines, and each of the six turbines is coupled to an individual pressure chamber, powering the turbine with a shaft 1550 connecting the rows.

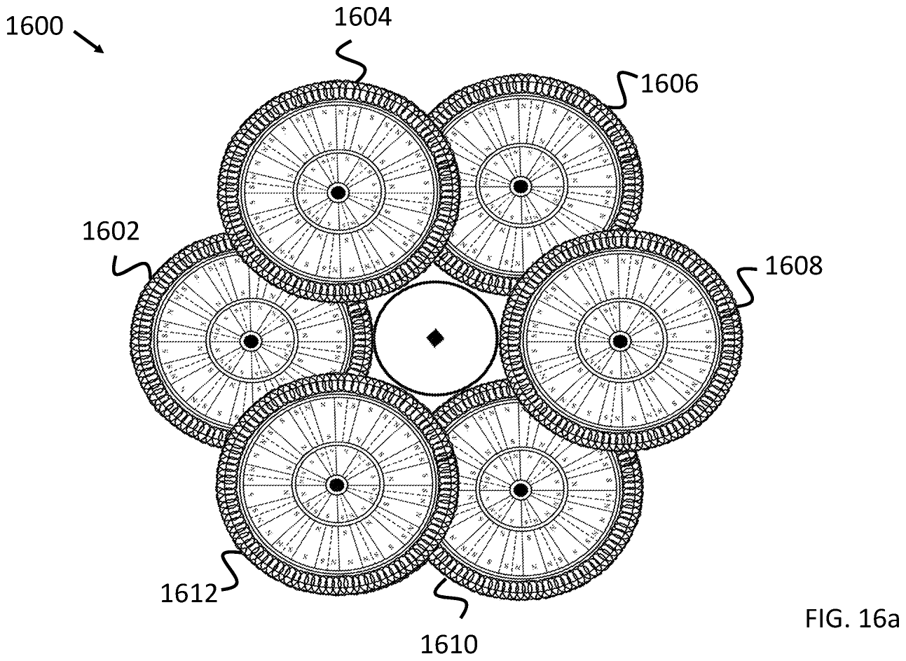

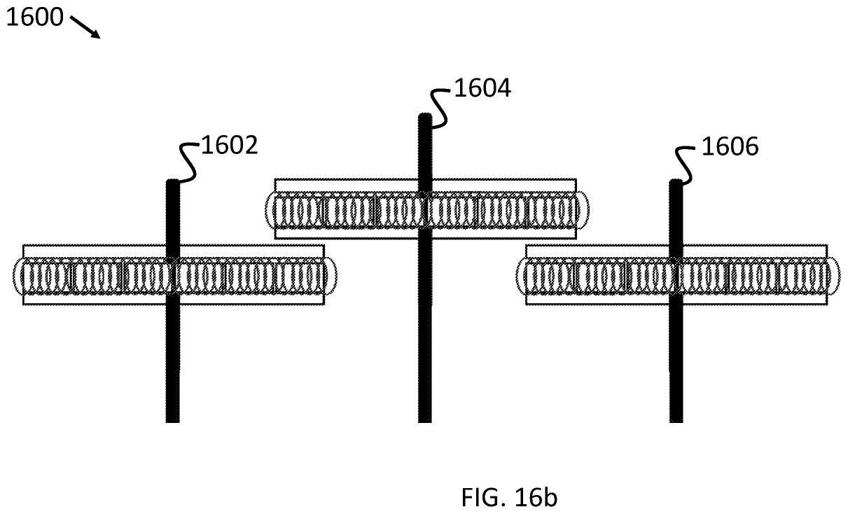

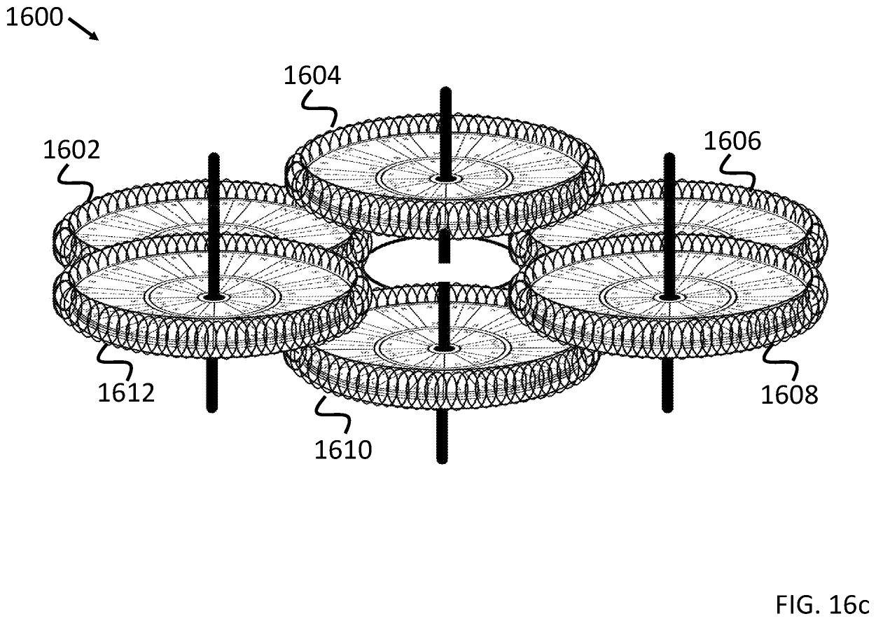

FIG. 16a depicts an example of a set of overlapping generation arrays 1600. FIG. 16b depicts an alternative example of a set of overlapping generation arrays 1600 from a side view. FIG. 16c depicts an alternative example of a set of overlapping generation arrays 1600 from a perspective view. FIG. 16a-c includes generation arrays 1602-1612. Generation Arrays 1602, 1606, and 1610 are located below generation arrays 1604, 1608 and 1612. In the example of FIG. 1600, each of the generation arrays 1602, 1606 and 1610 are sufficiently large that they are not constructed to be co-planar with generation arrays 1604, 1608 and 1612, and instead are organized into a lower level below generation arrays 1604, 1608, and 1612.

In the example of FIG. 16a-c, in operation, generation arrays 1604, 1608 and 1612 are rotated above generation arrays 1602, 1606 and 1610 to generate electricity. Efficiently, each of the generation arrays 1602-1612 are larger than would be possible if each were to be limited to the size that would allow generation arrays 1604-1612 to fit into a co-planar space.

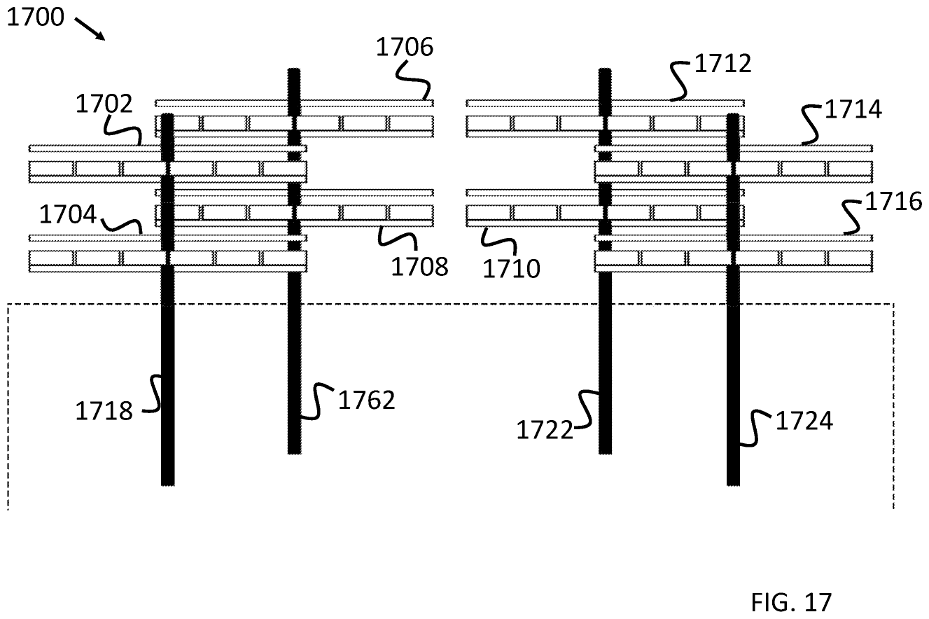

FIG. 17 depicts an example of a set of multiple generation arrays 1700. The set of multiple generation arrays 1700 includes generation arrays 1702-1716 and shafts 1718-1724. In the example of FIG. 17, generation arrays 1702 and 1704 are coupled to shaft 1718, generation arrays 1706 and 1708 are coupled to shaft 1720, generation arrays 1710 and 1712 are coupled to shaft 1722, generation arrays 1714 and 1716 are coupled to 1724. Generation Array 1708 is not coupled to shaft 1718, but rather is merely present in view in front of shaft 1718. Similarly, generation array 1710 is not coupled to shaft 1724 and is merely depicted in view in front of shaft 1724.

In the example of FIG. 17, each of shafts 1718-1724 operate two generation arrays, and more could be added. The additional generation arrays can be used to generate electricity and can serve as redundant generation arrays in the case of some failure of one or more other generation arrays.

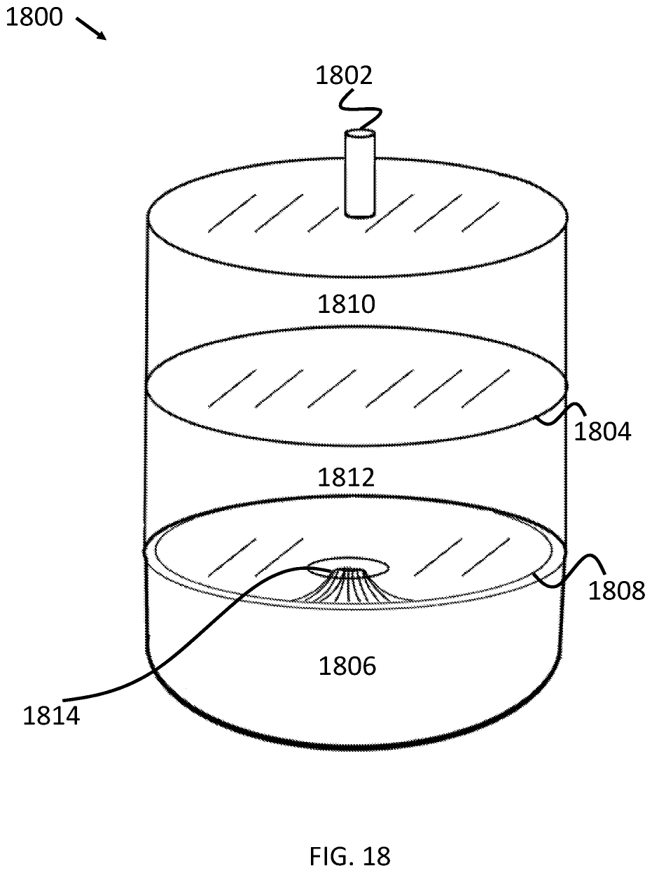

FIG. 18 depicts a housing 1800 for a Compressed Gas and Recycled Liquid Turbine Power System. In the example of FIG. 18, the housing 1800 includes housing input 1802, dividing plate 1804, liquid reservoir 1806, bottom plate 1808, dry region 1810, wet region 1812 and housing output 1814. In the example of FIG. 18, housing input 1802 can be a one-way check valve, opening, or other known or convenient device for allowing ambient air into the housing 1800. In the example of FIG. 18, the housing 1800 can be constructed of metal, plastic, or another known or convenient material and is divided into at least three areas, a dry region 1810, a wet region 1812, and liquid reservoir 1806. In the example of FIG. 18, dividing plate 1804 can be a physical divider constructed of metal, plastic, or another known or convenient material. In the example of FIG. 18 bottom plate 1808 can be a physical divider constructed of metal, plastic, or another known or convenient material. In the example of FIG. 18, the dividing plate 1804 has a wet-side and a dry-side and separates the wet region 1812 of the housing 1800 from the dry region 1810 of the housing 1800. In the example of FIG. 18, reservoir plate 1810, together with bottom plate 1808, and the remaining portion of the housing, form liquid reservoir 1806.

In the example of FIG. 18, in operation, ambient air is transferred through air input 1802 into the housing 1800 and exhaust is released through housing output 1812. Further, liquid reservoir 1806 maintains storage of liquid for use by the Compressed Gas and Recycled Liquid Turbine Power System.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A compressed gas and recycled liquid turbine power system comprising:
a pressure chamber receiving gas and liquid from a liquid reservoir, the pressure chamber operable to mix gas and liquid into a pressurized, emulsified gas-liquid;
a turbine power generator receiving the emulsified gas-liquid into the turbine and converting energy of the emulsified gas-liquid into rotational energy within the turbine;
a magnetically levitated generation array receiving the rotational energy of the turbine power generator and converting into electricity through proximately rotating a generation magnet within a generation induction coil; and
a vortex separator receiving the emulsified gas-liquid into an impeller rotationally separating the liquid from the gas and returning the liquid to the liquid reservoir for reuse.

2. The compressed gas and recycled liquid turbine power system of claim 1 wherein the turbine power generator includes six turbines coupled to a turbine shaft, each turbine included in its own turbine housing and operable to rotate the turbine shaft.

3. The compressed gas and recycled liquid turbine power system of claim 1 having six vortex separators, each of the six vortex separators including its own impeller coupled to a common vortex separator shaft.

4. The compressed gas and recycled liquid turbine power system of claim 2 having six turbine shafts, each having six turbines.

5. The compressed gas and recycled liquid turbine power system of claim 1 wherein the impeller of the vortex separator is coupled to an input for driving the vortex separator by external mechanical energy.

6. The compressed gas and recycled liquid turbine power system of claim 1 wherein gas is exhausted from the vortex separator.

7. The compressed gas and recycled liquid turbine power system of claim 1 wherein a direction inlet provides the emulsified gas-liquid to the turbine.

8. A method of generating electricity from stored energy comprising:
emulsifying a compressed gas in a liquid to create an emulsified gas-liquid;
operating a turbine using the emulsified gas-liquid;
magnetically levitating a generation array using rotational energy captured from the emulsified gas-liquid; and
converting the rotational energy of the generation array into electricity by rotating the generation array proximately to a coil.

9. The method of claim 8, further comprising, mechanically separating the emulsified gas liquid into gas and liquid using a vortex separator.

10. The method of claim 9, further comprising, exhausting gas out of the vortex separator.

11. The method of claim 8, further comprising directing the emulsified gas liquid via a direction inlet into a turbine housing.

12. The method of claim 8, further comprising transferring liquid from a vortex separator to a pressure chamber for emulsifying with the compressed gas.

13. The method of claim 8, further comprising translating energy from a gas output into rotational energy of a vortex separator shaft.

14. The method of claim 8 further comprising releasing gas from a vortex separator.

15. The method of claim 8 further comprising levitating the generation array.

16. A compressed gas and recycled liquid turbine power system of claim comprising:
a housing with a dry-side and a wet side, having,
a top plate,
a housing input with a one-way-in check valve on the dry-side,
a housing output below the wet-side,
a dividing plate between the dry-side and the wet-side,
a reservoir plate forming a liquid reservoir with a flow switch controlling a liquid supply,
an impeller pump within the liquid reservoir transferring liquid from the liquid reservoir, and
a bottom plate;
a pressure chamber having,
a pressure chamber liquid inlet receiving liquid from the impeller pump,
a pressure chamber liquid inlet valve controlling liquid entry into the pressure chamber,
a pressure chamber exhaust outlet operable to exhaust gas while filling the pressure chamber with liquid,
a pressure chamber exhaust outlet valve controlling release of gas from the pressure chamber,
a pressure chamber compressed gas inlet allowing compressed gas into the pressure chamber,
a pressure chamber compressed gas inlet valve controlling entry of compressed gas into the pressure chamber,
a pressure chamber emulsified gas liquid outlet releasing emulsified gas liquid, and
a pressure chamber emulsified gas liquid outlet valve controlling release of the emulsified gas liquid valve;
a turbine having,
a turbine emulsified gas liquid flow direction inlet directing emulsified gas liquid into a turbine housing,
a turbine driven by the emulsified gas liquid received from the turbine emulsified gas liquid flow direction inlet,
a turbine shaft coupled to the turbine passing through the dividing plate and having a tapered point, and
a turbine housing output-check-valve releasing the emulsified gas liquid;
a turbine power generator having,
a generation array coupled to the shaft disposed over a magnetically reflective plate coupled to the dividing plate on the dry-side of the housing,
a generating magnet included in the generation array, and
a coil disposed proximately to the generating magnet, which in operation, the generation array is magnetically levitated and generates electricity; and
a vortex separator having,
a vortex separator emulsified gas liquid input receiving emulsified gas liquid from the turbine housing output check valve,
a vortex separator liquid impeller blade separating liquid and gas from the emulsified gas liquid,
a vortex separator liquid output transferring liquid to the pressure chamber liquid input after separation from the emulsified gas liquid within the vortex separator,
a vortex separator gas output releasing gas from the vortex separator,
a vortex separator shaft centrally disposed within the housing, and
a vortex separator gas impeller coupled to the vortex separator shaft translating energy from the gas output into rotational energy of the vortex separator shaft.

17. The compressed gas and recycled liquid turbine power system of claim of claim 16 having six turbines coupled to the turbine shaft, each turbine included in its own turbine housing.

18. The compressed gas and recycled liquid turbine power system of claim of claim 16 having six vortex separators, each of the six vortex separators coupled to the vortex separator shaft.

19. The compressed gas and recycled liquid turbine power system of claim 17 having six turbine shafts each having six turbines.

20. The compressed gas and recycled liquid turbine power system of claim 18 having six turbine shafts, each turbine shaft having six turbines.

21. The compressed gas and recycled liquid turbine power system of claim 16 wherein the pressure chamber exhaust outlet valve is routed to a different pressure chamber.
